(19) United States
(12) Patent Application Publication
(10) Pub. No.: US 2026/0193080 A1
(43) Pub. Date: Jul. 9, 2026

(54) PROCESS FOR CATALYTIC CRACKING OF AMMONIA

(71) Applicant: Johnson Matthey Davy Technologies Limited, London (GB)

(72) Inventors: Julie Louise ASHCROFT, Royston Hertfordshire (GB); Andrew LAYTON, London (GB); Kate MCFARLANE, Stockton-On-Tees Cleveland (GB); John David PACH, Billingham Cleveland (GB); John SWINNEY, Stockton-On-Tees Cleveland (GB)

(21) Appl. No.: 19/132,262

(22) PCT Filed: Jan. 26, 2024
(86) PCT No.: PCT/GB2024/050206

§ 371 Date: May 22, 2025

(30) Foreign Application Priority Data
Jan. 27, 2023 (GB) 2301218.0

(51) Int. Cl. C01B 3/047; C01B 3/50

(52) U.S. Cl. CPC C01B 3/047; C01B 3/50; C01B 2203/0277; C01B 2203/04; C01B 2203/0827; C01B 2203/085; C01B 2203/1058; C01B 2203/1088; C01B 2203/141; C01B 2203/142; C01B 2203/1623; C01B 2203/1628

(57) ABSTRACT

The invention relates to the field of hydrogenpro-duction from the catalytic cracking of ammonia. The invention comprises a primary cracking pathway comprising one or more catalyst containing reaction tubes disposed within a fired ammonia cracking reactor; and a parallel cracking pathway comprising one or more secondary ammonia cracking reactors arranged sequentially and in fluid connection with one another. The invention may be used to produce hydrogen from ammonia.

### FIELD OF THE INVENTION

The present invention relates to a process for producing hydrogen gas. More specifically, the present invention relates to a process for producing hydrogen gas by catalytically cracking ammonia.

### BACKGROUND OF THE INVENTION

There is renewed interest in using hydrogen as a green, carbon free, fuel in a variety of industrial settings. Hydrogen may be combusted to produce heat energy or electricity.

Alternatively, hydrogen may be used to produce electrochemical energy in, for example, a fuel cell.

Ammonia has received interest as a possible compound to enable the storage and transport of hydrogen. Liquid ammonia has a higher hydrogen density than liquid hydrogen, and may be transported using existing infrastructure which is already in use for this purpose, such as that used for the transportation of ammonia in the agrochemical fertiliser industry.

Once the liquid ammonia has been transported it may be combusted directly or converted to hydrogen by the process of cracking.

The catalytic cracking of ammonia into hydrogen and nitrogen has been known for many years. The reaction may be depicted as follows:

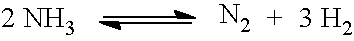

The ammonia cracking reaction is endothermic and may usefully be achieved by passing ammonia over a suitable catalyst in externally heated catalyst-containing reaction tubes disposed in a furnace. Such furnaces are known, for example, for the steam reforming of natural gas or naphtha feedstocks.

In industrial processes used for the catalytic cracking of ammonia, the gas produced by the ammonia cracking reaction is purified to produce a purified hydrogen stream and a waste gas stream. The waste gas comprises residual hydrogen, residual ammonia, and nitrogen.

The waste gas may be combusted with an oxygen containing gas to produce heat energy which may be used to support the endothermic cracking reaction in the furnace.

However, when combusted, the waste gas does not generate sufficient heat energy to sustain the ammonia cracking reaction in the furnace. This necessitates the combustion of one or more top-up fuel sources, such as ammonia, cracked ammonia gas, or an imported fuel (e.g. a hydrocarbon, for instance methane). Using top-up fuels which comprise processes gases (e.g. pure ammonia and/or pure hydrogen) is undesirable and may affect the overall conversion of the process. Using imported hydrocarbon fuels, such as methane, produces undesirable carbon dioxide emissions.

There remains a need for improved processes for the catalytic cracking of ammonia. In particular, there remains a need for improved processes for the catalytic cracking of ammonia which maximise the conversion of ammonia to produce hydrogen.

### SUMMARY OF THE INVENTION

Accordingly, the present invention provides a process for the catalytic cracking of ammonia, the process comprising providing:
a primary cracking pathway comprising one or more catalyst containing reaction tubes disposed within a fired ammonia cracking reactor; and
a parallel cracking pathway comprising one or more secondary ammonia cracking reactors arranged sequentially and in fluid connection with one another,
   the process comprising the steps of:
supplying a first ammonia stream to the primary cracking pathway;
cracking the ammonia in the first ammonia stream in the one or more catalyst containing reaction tubes of the fired ammonia cracking reactor to produce a first hydrogen containing stream;
supplying a second ammonia stream to the parallel cracking pathway;
cracking the ammonia in the second ammonia stream in the one or more secondary ammonia cracking reactors to produce a cracked second ammonia stream which further comprises unreacted ammonia;
withdrawing a second hydrogen containing stream from the parallel cracking pathway; feeding the second hydrogen containing stream to one or more purification units and increasing the hydrogen content of the second hydrogen containing stream to produce an enriched hydrogen stream and a tail gas stream; and
combusting the tail gas stream with oxygen in a fuel combustion zone of the fired ammonia cracking reactor to provide heat energy to support the cracking of the ammonia in the one or more catalyst containing reaction tubes,
   wherein the second hydrogen containing stream comprises from 40 mol % to 75 mol % H₂.

It has surprisingly been found that the process of the invention has superior hydrogen recovery and power efficiency. In particular, it has surprisingly been found that providing a parallel cracking pathway according to the invention, separating a tail gas from the resulting hydrogen containing stream, and combusting the tail gas in a fuel combustion zone may provide sufficient heat energy to support the endothermic ammonia cracking reaction in the fired ammonia cracking reactor of the primary cracking pathway. Moreover, it has surprisingly been found that the process of invention may reduce, or eliminate, the need to use a top-up fuel to support the endothermic ammonia cracking reaction in the fired ammonia cracking reactor.

Additionally, the parallel cracking pathway of the invention allows a smaller fired ammonia cracking reactor to be used, thereby reducing the capital and operating cost of the process.

### BRIEF DESCRIPTION OF THE DRAWINGS

FIG. 1 shows a block flow diagram of a process according to the invention.

FIG. 2 shows a schematic of the Compact Reformer available from Johnson Matthey Davy Technologies Limited.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The process of the invention comprises providing a primary cracking pathway comprising one or more catalyst containing reaction tubes disposed within a fired ammonia cracking reactor.

Suitable fired ammonia cracking reactors are known and may comprise a fuel combustion zone having a radiant section comprising one or more burners to which one or more fuel streams and an oxygen feed gas, such as air, oxygen enriched air, or oxygen, are fed. The radiant section may comprise the one or more catalyst containing reaction tubes though which the ammonia stream is passed. Combustion of one or more fuel streams in the one or more burners of the fuel combustion zone, creates heat energy (e.g. radiant heat) for heating the one or more catalyst containing reaction tubes. There may be tens or hundreds of catalyst containing reaction tubes in the radiant section. If desired, downstream of the radiant section, a flue gas from the combustion of the one or more fuel streams may be used to pre-heat one or more feed streams in a convection section. Reactors comprising a radiant section containing catalyst containing reaction tubes and a convection section for preheating feeds are known in steam methane reforming and may be applied to the present invention

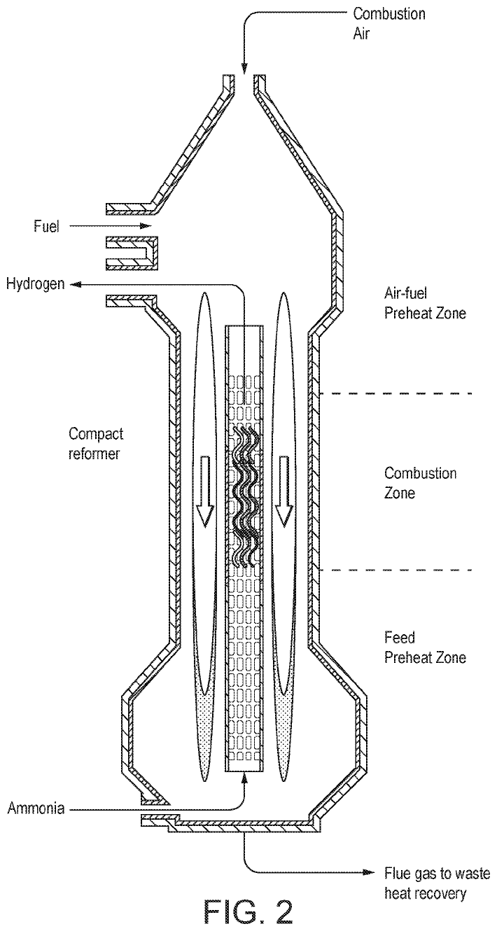

Alternatively, fired ammonia cracking reactors may be used where the combustion of the one or more fuel streams in a fuel combustion zone is separate to the reactor comprising the catalyst containing reaction tubes. Such a reactor is the compact reformer available from Johnson Matthey Davy Technologies Limited, a schematic of which is shown in FIG. 2.

The catalyst in the catalyst containing reaction tubes may be any ammonia cracking catalyst. For instance, nickel catalysts and/or ruthenium catalysts may be used. Preferred catalysts are nickel catalysts. The catalyst may comprise 3 to 30% by weight nickel, preferably 8 to 20% by weight nickel, expressed as NiO, on a suitable refractory support, such as alumina or a metal aluminate. The catalyst may be in the form of pelleted shaped units, which may comprise one or more through holes, or may be provided as a wash coat on a structured metal or ceramic catalyst. A particularly preferred catalyst is KATALCO^{RTM} 27-2 available from Johnson Matthey PLC, which comprises 12% nickel, expressed as NiO, on a cylindrical pellet formed from a high surface area calcium aluminate support.

The one or more catalyst containing reaction tubes may suitably be formed of an iron based alloy, a nickel based alloy, or a cobalt based alloy. The iron based alloy may be an iron-chromium based alloy such as a stainless steel, preferably 316 stainless steel, or a high nickel steel such as those described by WO03/051771A1. Preferably, the one or more catalyst containing reaction tubes are formed of a nickel based alloy or a cobalt based alloy More preferably, the one or more catalyst containing reaction tubes are formed of a cobalt based alloy.

The process of the invention comprises providing a parallel cracking pathway comprising one or more secondary ammonia cracking reactors arranged sequentially and in fluid connection with one another.

The one or more secondary ammonia cracking reactors may be in direct fluid connection or indirect fluid connection with one another.

The parallel cracking pathway of the invention is operated in parallel to the primary cracking pathway of the invention. The parallel cracking pathway and the primary cracking pathway are not sequential to one another; in other words, the cracked gas from the parallel cracking pathway or the primary cracking pathway may not be fed to the primary cracking pathway or the parallel cracking pathway, respectively, as a gas to be cracked.

The type of reactor which may be the one or more secondary ammonia cracking reactors are not particularly limited. The one or more secondary ammonia cracking reactors may be an adiabatic reactor, a packed bed reactor, an electrically heated reactor, and/or a gas fired reactor. Preferably, the one or more secondary ammonia reactors are adiabatic reactors, such as an adiabatic packed bed reactor.

Adiabatic reactors include reactors where no heat is transferred from the reactor to the second ammonia stream being fed to it. For example, an adiabatic reactor does not include a reactor which provides heat energy to the second ammonia stream.

The heat energy required to support the cracking reaction in the one or more secondary ammonia cracking reactors may be provided by heating the second ammonia stream and/or by providing a secondary ammonia cracking reactor which provides heat energy. Preferably, the heat energy may be provided from a source external to the process (e.g. imported gas or imported electricity).

For the avoidance of doubt, secondary ammonia cracking reactors function to crack ammonia to produce hydrogen and nitrogen.

The one or more secondary ammonia cracking reactors comprise a catalyst. The catalyst may be any catalyst for the cracking of ammonia. The catalyst may suitably be any one of those described above as being suitable for use with the fired ammonia cracking reactor.

It is an advantage of providing a parallel cracking pathway that additional ammonia may be cracked in the process without placing a duty on the fired ammonia cracking reactor of the primary cracking pathway. In particular, providing a parallel cracking pathway comprising one or more secondary ammonia cracking reactors allows ammonia to be cracked under kinetically favourable conditions (e.g. where the ammonia stream comprises a higher partial pressure of ammonia but a lower partial pressure of nitrogen and hydrogen) without the need for a complex and expensive fired ammonia cracking reactor. Moreover, the tail gas produced from purification of the hydrogen containing stream withdrawn from the parallel cracking pathway provides additional heat energy to support the cracking of ammonia in the fired ammonia cracking reactor.

The process of the invention comprises the step of supplying a first ammonia stream to the primary cracking pathway.

The first ammonia stream may be derived from any source. In preferred processes of the invention, the first ammonia stream is produced by the catalytic combination of hydrogen and nitrogen, for example the ammonia stream may be produced from a Haber-Bosch ammonia synthesis process. In preferred processes of the invention the first ammonia stream may be produced in an ammonia production facility located upstream of the ammonia cracking reactor. Alternatively, the first ammonia stream may be provided from an ammonia gas storage facility, an ammonia storage unit, an ammonia storage tank, or an ammonia gas pipeline.

The first ammonia stream may comprise 90 mol % ammonia or more, 95 mol % ammonia or more, 97 mol % ammonia or more, or 99 mol % ammonia or more. The first ammonia stream may be substantially 100 mol % ammonia. By “substantially 100 mol % ammonia” it is meant that any other component that may be present as an incidental impurity and may be present at an amount of less than 1 mol %, less than 0.5 mol %, or less than 0.1 mol % of the first ammonia stream.

The first ammonia stream may be combined with another ammonia containing stream before or after being fed to the primary cracking pathway. For example, the first ammonia stream may be combined with any process stream which comprises ammonia, such as a partially cracked ammonia stream and/or a tail gas stream.

In preferred processes of the invention the first ammonia stream may be heated prior to being supplied to the primary cracking pathway. In this instance, the first ammonia stream is a heated first ammonia stream. Accordingly, the process of the invention may comprise the step of heating the first ammonia stream. The first ammonia stream may be heated to a temperature of greater than 350° C., greater than 400° C., greater than 450° C., greater than 500° C., or greater than 550° C. The first ammonia stream may be heated to a temperature of less than 1000° C., less than 950° C., less than 850° C., less than 750° C., or less than 700° C. The first ammonia stream may be heated to a temperature of from 350° C. to 1000° C., from 400° C. to 950° C., from 450° C. to 850° C., or from 500° C. to 750° C., such as from 550° C. to 700° C.

The process of the invention comprises the step of cracking the ammonia in the first ammonia stream in the one or more catalyst containing reaction tubes of the fired ammonia cracking reactor to produce a first hydrogen containing stream.

The temperature of the first ammonia stream at the inlet to the one or more catalyst containing reaction tubes may be in the range of 350° C. to 1000° C., from 400° C. to 950° C., from 450° C. to 850° C., or from 500° C. to 750° C., such as from 550° C. to 700° C. The temperature of the first hydrogen containing stream exiting the one or more catalyst containing reaction tubes will influence the equilibrium position of the cracking reaction, and may be in the range of 500 to 950° C. Where nickel catalysts are used in the one or more catalyst containing reaction tubes, the temperature of the first hydrogen containing stream exiting the one or more catalyst containing reaction tubes may preferably be greater than about 700° C.

The pressure inlet to the one or more catalyst containing reaction tubes will be set by the flowsheet design and may be in the range 1 to 100 bar absolute, preferably 10 to 90 bar absolute, such as 31 to 51 bar absolute.

The first hydrogen containing stream contains H₂. The first hydrogen containing stream also contains nitrogen (N₂), and may further contain residual ammonia (e.g. unreacted ammonia).

The first hydrogen containing stream may comprise 60 mol % or more H₂, 65 mol % or more H₂, 70 mol % or more H₂, 72 mol % or more H₂, or 73 mol % or more H₂. The first hydrogen containing stream may comprise up to 75 mol % or less H₂. For example, the first hydrogen containing stream may comprise from 60 mol % to 75 mol % H₂. Preferably, the first hydrogen containing stream comprises from 70 mol % to 75 mol % H₂, such as 72 mol % to 75 mol % H₂.

The first hydrogen containing stream may comprise 20 mol % or more N₂, 21 mol % or more N₂, 22 mol % or more N₂, or 23 mol % N₂ or more. The first hydrogen containing stream may comprise up to 25 mol % or less N₂. For example, the first hydrogen containing stream may comprise from 20 mol % to 25 mol % N₂. Preferably the first hydrogen containing stream comprises from 22 mol % to 25 mol % N₂, such as from 23 mol % to 25 mol % N₂.

The first hydrogen containing stream may comprise less than 20 mol % NH₃, less than 15 mol % NH₃, less than 10 mol % NH₃, less than 5 mol % NH₃, less than 1 mol % NH₃, or less than 0.1 mol % NH₃. Preferably, the first hydrogen containing stream comprises less than 4 mol % NH₃, less than 2 mol % NH₃, less than 1 mol % NH₃, or less than 0.1 mol % NH₃.

Preferably, the first hydrogen containing stream may comprise an equilibrium mixture of ammonia, hydrogen, and nitrogen. In other words, the first hydrogen containing stream may comprise a mixture of ammonia, hydrogen, and nitrogen at partial pressures such that no further hydrogen and nitrogen may be produced from further cracking reaction. An equilibrium mixture may comprise from 72 mol % to 75 mol % H₂, from 23 mol % to 25 mol % N₂, and less than 4 mol % NH₃ (e.g. less than 1 mol % or less than 0.1 mol % NH₃).

The process of the invention comprises the step of supplying a second ammonia stream to the parallel cracking pathway.

The second ammonia stream may be obtained from any source. For example, the second ammonia stream may be obtained from the same or different source as the first ammonia stream.

The second ammonia stream may comprise 90 mol % ammonia or more, 95 mol % ammonia or more, 97 mol % ammonia or more, or 99 mol % ammonia or more. The second ammonia stream may be substantially 100 mol % ammonia. By “substantially 100 mol % ammonia” it is meant that any other component that may be present as an incidental impurity and may be present at an amount of less than 1 mol %, less than 0.5 mol %, or less than 0.1 mol % of the second ammonia stream.

It may be preferred that the second ammonia stream is heated before or after being fed to the parallel cracking pathway. The second ammonia stream may be heated using an electrical heater, or by using waste or recovered heat from elsewhere in the process. Alternatively, or additionally, the second ammonia stream may be heated by the one or more secondary ammonia cracking reactors (e.g. an electrically heated ammonia cracking reactor).

In preferred processes of the invention, the second ammonia stream and the first ammonia stream may be heated together to produce a heated first ammonia stream and a heated second ammonia stream from the same piece of process equipment. The heated first ammonia stream may be fed to the primary cracking pathway comprising the fired ammonia cracking reactor and the heated second ammonia stream may be fed to the parallel cracking pathway. For example, it may be preferred that the second ammonia stream is a portion of the first ammonia stream which has undergone heating to a temperature as described hereinabove. Accordingly, the process of the invention may comprise the steps of heating the first ammonia stream and the second ammonia stream in the same piece of process equipment.

The temperature to which the second ammonia stream is heated may be dependent upon the choice of catalyst in the subsequent first secondary ammonia cracking reactor and/or further secondary cracking reactors. For instance, when the first secondary ammonia cracking reactor uses a nickel containing catalyst, such as Katalco 27-2, the second ammonia stream is preferably heated to a temperature of from 700° C. to 1000° C., from 750° C. to 900° C., from 800° C. to 850° C. For instance, when the first secondary ammonia cracking reactor uses a noble metal catalyst (e.g. a ruthenium based catalyst), such as Katalco 27-612, the second ammonia stream may be heated to a temperature of from 450° C. to 650° C., from 500° C. to 600° C., or from 525° C. to 575° C. (e.g. about 550° C.). Typically, the second ammonia stream may be heated to a temperature of from 700° C. to 1000° C.

The process of the invention comprises the step of cracking the ammonia in the second ammonia stream in the one or more secondary ammonia cracking reactors to produce a cracked second ammonia stream which may further comprise unreacted ammonia.

The pressure inlet to the one or more secondary ammonia cracking reactors may typically be in the range 1 to 100 bar absolute, preferably 10 to 90 bar absolute, such as 31 to 51 bar absolute. Prior to supplying an ammonia stream to a secondary ammonia cracking reactor, the pressure may be set (e.g. increased) by a pump or compressor.

Typically, the cracked second ammonia stream exiting the first of the one or more secondary ammonia cracking reactors will comprise ammonia in an amount of from 65 mol % to 85 mol %, such as from 70 mol % to 80 mol %. Typically, the cracked second ammonia stream exiting the first of the one or more secondary ammonia cracking reactors will comprise hydrogen in an amount of from 10 mol % to 20 mol %, such as from 12.5 mol % to 17.5 mol %.

Typically, the cracked second ammonia stream exiting the first of the one or more secondary ammonia cracking reactors will comprise nitrogen in an amount of from 1 mol % to 10 mol %, such as from 3 mol % to 8 mol %. As will be understood, where more than one secondary ammonia cracking reactor is provided in the parallel cracking pathway, the amount of hydrogen and nitrogen will increase in the cracked second ammonia stream, whilst the amount of ammonia will decrease, for each sequential secondary ammonia cracking reactor the stream passes through. As will further be understood, the amount of ammonia cracked will depend upon the configuration of the secondary ammonia cracking reactors.

As will be understood, the temperature of an ammonia stream entering a secondary ammonia cracking reactor will be higher than the cracked ammonia stream exiting the secondary ammonia cracking reactor due to the endothermic nature of the ammonia cracking reaction.

The temperature of the cracked second ammonia stream after cracking the ammonia in a secondary ammonia cracking reactor will dependent upon the choice of catalyst used in the secondary ammonia cracking reactor. Typically, when the secondary ammonia cracking reactor uses a nickel catalyst, such as Katalco 27-2, the cracked second ammonia stream may have a temperature of from 450° C. to 600° C., such as from 500° C. to 550° C. after cracking in the secondary ammonia cracking reactor. Typically, when the secondary ammonia cracking reactor uses a noble metal catalyst (e.g. a ruthenium based catalyst), such as Katalco 27-612, the cracked second ammonia stream may have a temperature of from 350° C. to 500° C., such as from 400° C. to 450° C., after cracking in the secondary ammonia cracking reactor.

The process of the invention comprises the step of withdrawing a second hydrogen containing stream from the parallel cracking pathway.

Following the ammonia cracking reaction in the one or more secondary ammonia cracking reactors of the parallel cracking pathway a second hydrogen containing stream is produced.

The second hydrogen containing stream is withdrawn from the parallel cracking pathway. For the avoidance of doubt, the second hydrogen containing stream withdrawn from the parallel cracking pathway may be the cracked second ammonia stream after it has undergone cracking in all of the one or more secondary ammonia cracking reactors.

The second hydrogen containing stream comprises from 40 mol % to 75 mol % H₂. The second hydrogen containing stream may comprise 50 mol % or more H₂, or 60 mol % or more H₂. The second hydrogen containing stream comprises up to 75 mol % or less H₂. For example, the second hydrogen containing stream may comprise from 50 mol % to 75 mol % H₂, or from 60 mol % to 75 mol % H₂.

The second hydrogen containing stream may comprise 20 mol % or more N₂, 21 mol % or more N₂, 22 mol % or more N₂, or 23 mol % N₂ or more. The second hydrogen containing stream may comprise up to 25 mol % or less N₂. For example, the second hydrogen containing stream may comprise from 20 mol % to 25 mol % N₂. Preferably the second hydrogen containing stream comprises from 22 mol % to 25 mol % N₂, such as from 23 mol % to 25 mol % N₂.

The second hydrogen containing stream may comprise less than 20 mol % NH₃, less than 15 mol % NH₃, less than 10 mol % NH₃, less than 5 mol % NH₃, less than 1 mol % NH₃, or less than 0.1 mol % NH₃. Preferably, the second hydrogen containing stream comprises less than 4 mol % NH₃, less than 2 mol % NH₃, less than 1 mol % NH₃, or less than 0.1 mol % NH₃.

Preferably, the second hydrogen containing stream may comprise an equilibrium mixture of ammonia, hydrogen, and nitrogen. In other words, the second hydrogen containing stream may comprise a mixture of ammonia, hydrogen, and nitrogen at partial pressures such that no further hydrogen and nitrogen may be produced from further cracking reactions. An equilibrium mixture may comprise from 72 mol % to 75 mol % H₂, from 23 mol % to 25 mol % N₂, and less than 4 mol % NH₃ (e.g. less than 1 mol % or less than 0.1 mol % NH₃).

The process of the invention comprises the step of feeding the second hydrogen containing stream to one or more purification units and increasing the hydrogen content of the second hydrogen containing stream to produce an enriched hydrogen stream and a tail gas stream.

The second hydrogen containing stream is fed to one or more purification units, such as a pressure swing absorption unit, to increase the H₂ content by separating H₂ from the other components. In preferred processes of the invention, the first hydrogen containing stream, from the primary cracking pathway, and the second hydrogen containing stream, from the parallel cracking pathway, may be fed to the one or more purification units to produce one or more enriched hydrogen containing streams and one or more tail gas streams. In preferred processes of the invention the first hydrogen containing stream and the second hydrogen containing stream may be fed to the same purification unit or may each be fed to different purification units.

In the instance where the first hydrogen containing stream and the second hydrogen containing stream are fed to the same purification unit, it will be understood that the enriched hydrogen stream may be recovered as a single enriched hydrogen stream from the purification unit. In the instance where the first hydrogen containing stream and the second hydrogen containing stream are fed to different purification units the enriched hydrogen stream may be obtained as multiple enriched hydrogen streams which may be optionally combined to form a single enriched hydrogen stream.

It may be preferred that prior to feeding the first hydrogen containing stream and/or the second hydrogen containing stream to the one or more purification units that the first and/or second hydrogen containing streams are fed to a steam generation unit and/or a heat recovery zone. As will be understood by the skilled person the steam generation unit and/or the heat recovery zone may be used to recover low or medium grade heat.

It may be preferred that the first hydrogen containing stream and the second hydrogen containing stream both comprise an equilibrium mixture of hydrogen, nitrogen, and ammonia, as described hereinabove.

In the process of the invention, the tail gas, produced from the first and second hydrogen containing stream, is combusted with oxygen to provide heat energy to support the cracking of the ammonia in the one or more catalyst containing reaction tubes. The higher the hydrogen content of the first hydrogen containing stream and/or the second hydrogen containing stream, the higher the amount of hydrogen in the tail gas. It is therefore surprising that when the first hydrogen containing stream and/or the second hydrogen containing stream both comprise higher hydrogen contents (e.g. 40 mol % or more, preferably an equilibrium mixture of hydrogen, nitrogen, and ammonia) that the overall hydrogen recovery of the process may be maximised at a higher power efficiency. It may therefore be preferred that the first hydrogen containing stream and the second hydrogen containing stream both comprise a high hydrogen content (e.g. 40 mol % or more, preferably an equilibrium mixture of hydrogen, nitrogen, and ammonia), and that the tail gas may comprise a composition as defined hereinbelow.

The enriched hydrogen stream may comprise 70 mol % or more H₂, 75 mol % or more H₂, 80 mol % or more H₂, 85 mol % H₂ or more, or 90 mol % H₂ or more. The enriched hydrogen stream may comprise up to 100 mol % or less H₂. For example, the enriched hydrogen stream may comprise from 70 mol % to 100 mol % H₂, from 75 mol % to 100 mol % H₂, from 80 mol % to 100 mol % H₂, from 85 mol % to 100 mol % H₂, or from 90 mol % to 100 mol % H₂. Preferably, the enriched hydrogen stream may comprise greater than 90 mol % H₂, greater than 95 mol % H₂, greater than 98 mol % H₂, or greater than 99 mol % H₂. More preferably, the enriched hydrogen stream may comprise greater than 99.9% mol % H₂, greater than 99.95 mol % H₂, or about 100 mol % H₂. Most preferably, the enriched hydrogen containing stream may comprise greater than 99.95 mol % H₂ or about 100 mol % H₂.

The enriched hydrogen stream may be further purified to produce a purified hydrogen product. The enriched hydrogen stream may have a purity sufficiently high so as to be a purified hydrogen product.

In the instance where the first hydrogen containing stream and the second hydrogen containing stream are fed to the same purification unit, it will be understood that the tail gas stream may be recovered as a single tail gas stream. In the instance where the first hydrogen containing stream and the second hydrogen containing stream are fed to different purification units the tail gas streams may be obtained as multiple tail gas streams which may be optionally combined to form a single tail gas stream.

The tail gas stream may comprise nitrogen (N₂), ammonia, and hydrogen (H₂). The composition of the tail gas stream will be dependent upon the configuration of the primary and parallel cracking pathways and the composition of the hydrogen containing streams being withdrawn therefrom.

Typically, the tail gas stream may comprise from 20 mol % to 95 mol % N₂, from 45 mol % to 85 mol % N₂, or from 65 mol % to 80 mol % N₂.

Typically, the tail gas stream may comprise from 3 mol % to 10 mol % ammonia, from 3.2 mol % to 7 mol % ammonia, or from 3.3 mol % to 5 mol % ammonia.

Typically, the tail gas stream may comprise from 10 mol % to 70 mol % H₂, such as from 20 mol % to 50 mol % H₂. It may be preferred that the tail gas stream comprises from 15 mol % to 40 mol % H₂, from 20 mol % H₂ to 35 mol % H₂, or from 22 mol % H₂ to 30 mol % H₂.

The process of the invention comprises the step of combusting the tail gas stream with oxygen in a fuel combustion zone of the fired ammonia cracking reactor to provide heat energy to support the cracking of the ammonia in the one or more catalyst containing reaction tubes.

The oxygen used to combust the one or more tail gas streams may suitably be or comprise air, compressed air, oxygen enriched air, oxygen, oxygen and an inert gas such as nitrogen.

As described hereinabove, the fuel combustion zone may be within the fired ammonia cracking reactor or may be within a separate vessel for the combustion which is fluidly connected to the fired ammonia cracking reactor.

In preferred process of the invention, the parallel cracking pathway may comprise providing two or more, three or more, four or more, or five or more, secondary ammonia cracking reactors arranged sequentially.

Where two or more secondary ammonia cracking reactors are provided the second ammonia stream is supplied to each sequentially arranged secondary ammonia cracking reactor to produce, in each case, a cracked second ammonia stream. As the cracked second ammonia stream passes through each sequential secondary ammonia cracking reactor further ammonia is cracked and the composition of the second ammonia stream changes. The term “cracked second ammonia stream” is used to refer to a second ammonia stream which has passed through at least one secondary ammonia cracking reactor and the ammonia in said stream has been cracked.

The total number of secondary ammonia cracking reactors which may be present in the parallel cracking pathway is not particularly limited and will depend upon the desired composition of the second hydrogen containing stream which is withdrawn from the parallel cracking pathway, the catalysts used, and the temperature of the second ammonia stream and/or cracked second ammonia stream. Preferably, sufficient secondary ammonia cracking reactors are provided such that the second hydrogen containing stream is withdrawn from the parallel cracking pathway as an equilibrium mixture, as described hereinabove.

Accordingly, the parallel cracking pathway preferably comprises two or more, three or more, four or more, or five or more secondary ammonia cracking reactors arranged sequentially and in fluid communication with one another. Accordingly, the process of the invention may comprise the step of supplying the cracked second ammonia stream to a second, a third, a fourth, and/or a fifth secondary ammonia cracking reactor of the parallel cracking pathway.

The catalyst used in each of the one or more secondary ammonia cracking reactors may be the same or different to one another.

In preferred processes of the invention the temperature of the cracked second ammonia stream exiting any one secondary ammonia cracking reactor is sufficiently high for the cracking of ammonia to occur in a subsequent secondary ammonia cracking reactor without requiring an intermediate re-heating step.

Accordingly, the process of the invention may comprise the step of passing the cracked second ammonia stream to one or more subsequent secondary ammonia cracking directly without an intermediate re-heating step.

In preferred processes of the invention the parallel cracking pathway comprises two or more secondary ammonia cracking reactors arranged sequentially and in fluid connection with one another.

In a preferred embodiment of the invention, the first of the two or more secondary ammonia cracking reactors may comprise a catalyst which operates at a high temperature (for example a catalyst which catalyses the cracking of ammonia at a temperature of from 700° C. to 1000° C.) and the second of the secondary ammonia cracking reactors may be comprise a catalyst which operates at a lower temperature (for example a catalyst which catalyses the cracking of ammonia at a temperature of from 450° C. to 650° C.).

In a more preferred embodiment of the invention, the first of the two or more secondary ammonia cracking reactor may comprise a nickel containing catalyst and the second of the secondary ammonia cracking reactors may comprise a noble metal containing catalyst (e.g. a ruthenium based catalyst). Preferably, in this configuration, the cracked second ammonia stream is passed from the first of the two or more secondary ammonia cracking reactor to the second of the two or more secondary ammonia cracking reactors without an intermediate heating step.

It is an advantage of the present invention that two secondary ammonia cracking reactors arranged sequentially and comprising different catalysts can be provided and that ammonia can be cracked across a wide temperature range by exploiting the different activities of the catalysts.

The parallel cracking pathway may comprise one or more heaters.

Heaters may be provided to increase the temperature of the cracked second ammonia stream and to provide sufficient heat energy for the ammonia in the cracked second ammonia stream to be cracked.

The one or more heaters may be powered or fuelled by burning a gas, such as a hydrocarbon gas, hydrogen, or ammonia, or by electricity. The one or more heaters may be preferably powered or fuelled from a source external to the process (e.g. imported gas or imported electricity).

The one or more heaters are preferably electrical heaters. Preferably the one or more heaters are electrical heaters which draw electricity generated outside of the process. Even more preferably, the one or more heaters are electrical heaters which draw electricity generated from a renewable source, for example from wind, solar, hydroelectrical, or tidal sources.

The one or more heaters may be part of the one or more secondary ammonia cracking reactors. For example, the one or more heaters may form part of an electrically heated packed bed reactor.

In preferred processes of the invention, the one or more secondary ammonia cracking reactors may be adiabatic reactors and heat energy to support the cracking reaction in the one or more secondary ammonia cracking reactors may be provided by heating the second ammonia stream using one or more heaters.

The process of the invention may comprise the step of re-heating the cracked second ammonia stream using a heater (e.g. an electrical heater) to produce a re-heated cracked second ammonia stream.

The process of the invention may comprise re-heating the cracked second ammonia stream and feeding it to one or more subsequent secondary ammonia cracking reactors. The step of re-heating the cracked second ammonia stream has the advantage that subsequent secondary ammonia cracking reactors may be provided to convert unreacted ammonia in the cracked second ammonia stream. The process of the invention may comprise providing a heater (e.g. an electrical heater) disposed upstream of a secondary ammonia cracking reactor.

Accordingly, the process may comprise the step of re-heating the cracked second ammonia stream using a heater (e.g. an electrical heater) to produce a re-heated cracked second ammonia stream, and supplying the re-heated cracked second ammonia stream to one or more subsequent secondary ammonia cracking reactors.

The temperature to which the cracked second ammonia stream is re-heated will depend upon the nature of the catalysts used in the one or more secondary ammonia cracking reactors. For instance, when the secondary ammonia cracking reactor uses a nickel containing catalyst, such as Katalco 27-2, the cracked second ammonia stream may be re-heated to a temperature of from 700° C. to 1000° C., from 750° C. to 900° C., from 800° C. to 850° C. For instance, when the one or more secondary ammonia cracking reactors uses a noble metal catalyst (e.g. a ruthenium based catalyst), such as Katalco 27-612, the cracked second ammonia stream may be re-heated to a temperature of from 450° C. to 650° C., from 500° C. to 600° C., or from 525° C. to 575° C. (e.g. about 550° C.). Typically, the cracked second ammonia stream may be re-heated to a temperature of from 700° C. to 1000° C.

It is an advantage of using heaters powered or fuelled from a source external to the process in re-heating the second ammonia stream that the consumption of raw materials (e.g. pure ammonia) or product materials (e.g. pure hydrogen) to provide heat energy to the ammonia cracking reaction is reduced or eliminated. It is a particular advantage that the one or more heaters are electrical heaters. Whilst electrical energy needs to be used by the electrical heaters, it has surprisingly been found that the overall power efficiency of the process of the invention is higher than when electrical heaters and secondary ammonia cracking reactors are not employed.

The need to provide a heater (e.g. an electrical heater) at any point in the process of the invention will depend upon the number of secondary ammonia cracking reactors used, the nature of the catalyst disposed within each of the secondary ammonia cracking reactors, the temperature of the second ammonia stream and/or cracked second ammonia stream following the cracking reaction in each of the secondary ammonia cracking reactor, and the desired composition of the second hydrogen containing stream withdrawn from the parallel ammonia cracking pathway.

In a preferred process of the present invention, the parallel cracking pathway comprises three or more secondary ammonia cracking reactors, and the process comprises the steps of:
supplying a second ammonia stream to the parallel cracking pathway;
cracking the ammonia in the second ammonia stream in the one or more secondary ammonia cracking reactors to produce a cracked second ammonia stream which further comprises unreacted ammonia; and
re-heating the cracked second ammonia stream using a heater (e.g. an electrical heater) to a temperature of from 700° C. to 1000° C. to produce a re-heated cracked second ammonia stream;
supplying the re-heated cracked second ammonia stream to a secondary ammonia cracking reactor comprising a nickel containing catalyst (e.g. Katalco 27-2); and
optionally, re-heating the cracked second ammonia stream using a heater (e.g. an electrical heater) to a temperature of from 700° C. to 1000° C. to produce a re-heated cracked second ammonia stream; and
supplying the re-heated cracked second ammonia stream to a secondary ammonia cracking reactor comprising a nickel containing catalyst (e.g. Katalco 27-2).

In a preferred process of the present invention, the parallel cracking pathway comprises three or more secondary ammonia cracking reactors, and the process comprises the steps of:
supplying a second ammonia stream to the parallel cracking pathway;
cracking the ammonia in the second ammonia stream in the one or more secondary ammonia cracking reactors to produce a cracked second ammonia stream which further comprises unreacted ammonia;
re-heating the cracked second ammonia stream using a heater (e.g. an electrical heater) to a temperature of from 700° C. to 1000° C. to produce a re-heated cracked second ammonia stream;
supplying the re-heated cracked second ammonia stream to a secondary ammonia cracking reactor comprising a nickel containing catalyst (e.g. Katalco 27-2); supplying the cracked second ammonia stream directly (i.e. without an intermediate
re-heating step) to a secondary ammonia cracking reactor comprising a noble metal containing catalyst (e.g. Katalco 27-612);
re-heating the cracked second ammonia stream using a heater (e.g. an electrical heater) to a temperature of from 700° C. to 1000° C.; and
supplying the cracked second ammonia stream to a secondary ammonia cracking reactor comprising a nickel containing catalyst (e.g. Katalco 27-2).

In certain processes of the invention, in addition to the tail gas stream, one or more fuel streams may be combusted with oxygen in the fuel combustion zone such that the combustion provides heat energy which is used to support the endothermic ammonia cracking reaction in the ammonia cracking reactor. Accordingly, the process of the invention may comprise the step of combusting one or more fuel streams with oxygen in the fuel combustion zone to provide heat energy to the fired ammonia cracking reactor.

Preferably, the one or more fuel sources may comprise carbon-free fuel sources (e.g. hydrogen or ammonia). It may be preferred that the one or more fuel sources do not comprise carbon containing fuel sources.

The one or more fuel streams may comprise one or more of hydrogen, natural gas, methane, refinery off gas, biogas, the tail gas from the hydrogen purification unit, a fuel portion of the first or the second hydrogen containing stream, or a fuel portion of the enriched hydrogen containing stream from the one or more purification units.

As used herein, the term “fuel portion” is used to refer to a portion of a stream (for example the hydrogen containing stream, the enriched hydrogen containing stream, or the first or the second ammonia stream) which is used as a fuel source. It is not used to refer to a portion of a stream used in the ammonia cracking reaction.

In certain processes of the invention, the one or more fuel streams may comprise a hydrogen containing fuel stream. The hydrogen containing fuel stream may be a fuel portion of the hydrogen containing stream produced from the ammonia cracking reactor. The hydrogen containing fuel stream may be a fuel portion of the enriched hydrogen containing stream from the purification unit. Accordingly, the process of the invention may comprise the step of taking a fuel portion of the hydrogen containing stream or a fuel portion of the enriched hydrogen stream, and combusting the fuel portion of the hydrogen containing stream or the fuel portion of the enriched hydrogen containing stream with oxygen in a fuel combustion zone to provide heat energy to support the endothermic ammonia cracking reaction in the ammonia cracking reactor.

For the avoidance of doubt the one or more fuel streams may be combined with one another and/or the tail gas stream prior to combustion, or each stream may be combined at a single point of combustion.

The combustion of the tail gas stream and, optionally the one or more fuel streams, in the fuel combustion zone generates a flue gas, which may be recovered from the fired ammonia cracking reactor. The flue gas may be cooled in one or more cooling stages and may be subjected to one or more purification stages before being discharged to atmosphere. The one or more cooling stages may comprise recovering heat energy from the flue gas. For example, the one or more cooling stages may include a preheating stage for one or more of the reactants for the fired and/or secondary ammonia cracking reactors and/or generating steam. The one or more purification stages may include a stage of selective catalytic reduction, or SCR, in which nitrogen oxides are reacted with ammonia to form nitrogen and water vapour. Any flue-gas selective catalytic reduction technology may be used.

In preferred process of the invention, the process comprises providing:
a primary cracking pathway comprising one or more catalyst containing reaction tubes disposed within a fired ammonia cracking reactor; and
a parallel cracking pathway comprising one or more secondary ammonia cracking reactors arranged sequentially and in fluid connection with one another,
   the process comprising the steps of:
supplying a first ammonia stream to the primary cracking pathway;
cracking the ammonia in the first ammonia stream in the one or more catalyst containing reaction tubes of the fired ammonia cracking reactor to produce a first hydrogen containing stream;
supplying a second ammonia stream to the parallel cracking pathway;
cracking the ammonia in the second ammonia stream in the one or more secondary ammonia cracking reactors to produce a cracked second ammonia stream which further comprises unreacted ammonia;
withdrawing a second hydrogen containing stream from the parallel cracking pathway; feeding the second hydrogen containing stream, and optionally the first hydrogen containing stream, to one or more purification units and increasing the hydrogen content of the second hydrogen containing stream, and optionally the first hydrogen containing stream, to produce an enriched hydrogen stream and a tail gas stream; and combusting the tail gas stream with oxygen in a fuel combustion zone of the fired ammonia cracking reactor to provide heat energy to support the cracking of the ammonia in the one or more catalyst containing reaction tubes.

In a preferred process of the invention, the process comprises providing:
a primary cracking pathway comprising one or more catalyst containing reaction tubes disposed within a fired ammonia cracking reactor; and
a parallel cracking pathway comprising one or more secondary ammonia cracking reactors arranged sequentially and in fluid connection with one another,
   the process further comprising the steps of:
supplying a first ammonia stream to the primary cracking pathway;
cracking the ammonia in the first ammonia stream in the one or more catalyst containing reaction tubes of the fired ammonia cracking reactor to produce a first hydrogen containing stream;
supplying a second ammonia stream to the parallel cracking pathway;
cracking the ammonia in the second ammonia stream in the one or more secondary ammonia cracking reactors to produce a cracked second ammonia stream which further comprises unreacted ammonia;
re-heating the cracked second ammonia stream using a heater (e.g. an electrical heater) to produce a re-heated cracked second ammonia stream;
supplying the re-heated cracked second ammonia stream to one or more subsequent secondary ammonia cracking reactors;
cracking the ammonia in the re-heated cracked second ammonia stream in the one or more subsequent secondary ammonia cracking reactors;
withdrawing a second hydrogen containing stream from the parallel cracking pathway; feeding the second hydrogen containing stream, and optionally the first hydrogen containing stream, to one or more purification units and increasing the hydrogen content of the second hydrogen containing stream, and optionally the first hydrogen containing stream, to produce an enriched hydrogen stream and a tail gas stream; and combusting the tail gas stream with oxygen in a fuel combustion zone of the fired ammonia cracking reactor to provide heat energy to support the cracking of the ammonia in the one or more catalyst containing reaction tubes.

The invention will now be described in further detail in the following non-limiting embodiments and with reference to the Figures.

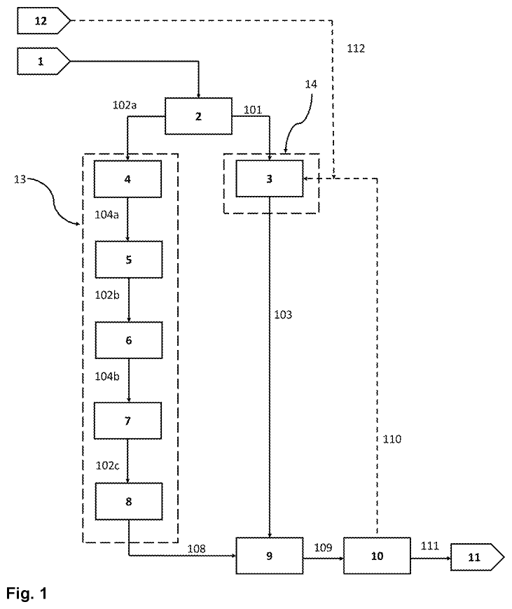

FIG. 1 illustrates a block flow diagram of a process according to the invention. FIG. 1 shows an ammonia stream (1) being fed to a heating unit (2) which heats the ammonia stream to produce a first ammonia stream (101) and a second ammonia stream (102a). The first ammonia stream (101) is supplied to a primary cracking pathway (14). The primary cracking pathway (14) comprises one or more catalyst containing reaction tubes disposed within the fired ammonia cracking reactor (3). The ammonia in the first ammonia stream is cracked in the one or more catalyst containing reaction tubes of the fired ammonia cracking reactor (3) to produce a first hydrogen containing stream (103). The second ammonia stream (102a) is supplied to a parallel ammonia cracking pathway (13). The parallel ammonia cracking pathway comprises one or more secondary ammonia cracking reactors (4, 6, 8) arranged sequentially and in fluid connection with one another, and electrical heaters (5, 7). The second ammonia stream (102a) is supplied to a first secondary ammonia cracking reactor (4). The ammonia in the second ammonia stream (102a) is cracked in the first secondary ammonia cracking reactor (4) to produce a cracked second ammonia stream (104a) which further comprises unreacted ammonia. At this stage the temperature of the cracked second ammonia stream (104a) will be lower than that of the ammonia stream (102a) entering the first secondary ammonia cracking reactor (4). The second ammonia stream (104a) is fed to an electrical heater (5) where it is re-heated. The re-heated cracked second ammonia stream (102b) is supplied to a second secondary ammonia cracking reactor (6) where unreacted ammonia is cracked and a cracked second ammonia stream (104b) is obtained. The cracked second ammonia stream (104b) is fed to a further electrical heater (7) where it is re-heated. The re-heated cracked second ammonia stream (102c) is supplied to a third secondary ammonia cracking reactor (8) where unreacted ammonia is cracked and a second hydrogen containing stream (108) is obtained and withdrawn from the parallel ammonia cracking pathway (13). The second hydrogen containing stream may be a cracked ammonia gas stream at, or near, equilibrium. The first hydrogen containing stream (103) and the second hydrogen containing stream (108) are fed to a heat recovery unit (9) where heat is recovered. The first hydrogen containing stream (103) and the second hydrogen containing stream (103) are combined and fed as a single stream (109) to a purification unit (10). The purification unit (10) increases the hydrogen content of the hydrogen containing stream (109) and produces an enriched hydrogen stream (111) and a tail gas stream (110). The enriched hydrogen stream (111) may be recovered as a purified hydrogen product (11). The tail gas (110) is supplied to the fired ammonia cracking reactor (3) and combusted with oxygen of an oxygen containing feed (112) in a fuel combustion zone of the fired ammonia cracking reactor (3) to provide heat energy to support the cracking of the ammonia in the one or more catalyst containing reaction tubes.

### EXAMPLES

An ammonia cracking process as described above and illustrated in FIG. 1 was compared with a process utilising only a fired reactor. The hydrogen recovery and power efficiencies of each were compared. Both processes were based on the cracking of an ammonia stream comprising 50 tonnes per hour ammonia.

### Multi-Bed Cracker (According to the Invention)

58.3% of the ammonia was directed to the secondary bed stream, 40.0% to the fired cracker and 1.5% to fuel. 28.8 MW of electrical energy was imported. 0.2% to SCR for NOx abatement

### Fired Cracker Only (Comparative)

85% of the ammonia was directed to the fired cracker and 14.6% to fuel. 1.7 MW of electrical energy was generated via a steam turbine for export.

The overall recoveries are shown in Table 1.

TABLE 1

| | Electrical & Fired (according to | |
|---|---|---|
| | the invention) | Fired Only (comparative) |
| Hydrogen recovery* | 86.69% | 74.8% |
| Power efficiency ** | 89.42% | 86.4% |

*Hydrogen recovery is defined as:
$\frac{Actual hydrogen production [ kmol / h ]}{Hydrogen production for 100 \% ammonia conversion to hydrogen [ kmol / h ]}$ ** Power efficiency is defined as:
$\frac{Energy in product hydrogen stream ( based on LHV ) [ MW ] + Electrical Export [ MW ] - Electrical Import [ MW ]}{Energy in ammonia feed stream ( based on LHV )}$

The process of the invention, which utilises secondary ammonia cracking reactors arranged in sequence, recovers significantly more hydrogen than a process which comprises only a fired ammonia cracking reactor. Moreover, the increased hydrogen recovery of the process of the invention is achieved at a higher power efficiency.

1. A process for the catalytic cracking of ammonia, the process comprising providing:
a primary cracking pathway comprising one or more catalyst containing reaction tubes disposed within a fired ammonia cracking reactor; and
a parallel cracking pathway comprising one or more secondary ammonia cracking reactors arranged sequentially and in fluid connection with one another, the process comprising the steps of:
supplying a first ammonia stream to the primary cracking pathway;
cracking the ammonia in the first ammonia stream in the one or more catalyst containing reaction tubes of the fired ammonia cracking reactor to produce a first hydrogen containing stream;
supplying a second ammonia stream to the parallel cracking pathway;
cracking the ammonia in the second ammonia stream in the one or more secondary ammonia cracking reactors to produce a cracked second ammonia stream which further comprises unreacted ammonia;
withdrawing a second hydrogen containing stream from the parallel cracking pathway;
feeding the second hydrogen containing stream to one or more purification units and increasing the hydrogen content of the second hydrogen containing stream to produce an enriched hydrogen stream and a tail gas stream; and
combusting the tail gas stream with oxygen in a fuel combustion zone of the fired ammonia cracking reactor to provide heat energy to support the cracking of the ammonia in the one or more catalyst containing reaction tubes,
wherein the second hydrogen containing stream comprises from 40 mol % to 75 mol % H₂.

2. A process according to claim 1, wherein the first ammonia stream comprises 90 mol % ammonia or more, 95 mol % ammonia or more, 97 mol % ammonia or more, 99 mol % ammonia or more, or substantially 100 mol % ammonia.

3. A process according to claim 1, wherein the second ammonia stream may comprise 90 mol % ammonia or more, 95 mol % ammonia or more, 97 mol % ammonia or more, 99 mol % ammonia or more, or substantially 100 mol % ammonia.

4. A process according to claim 1, the process comprising the step of heating the first ammonia stream to a temperature of from 350° C. to 1000° C., from 400° C. to 950° C., from 450° C. to 850° C., or from 500° C. to 750° C.

5. A process according to claim 1, wherein the pressure inlet to the one or more catalyst containing reaction tubes is in the range of from 1 to 100 bar absolute, preferably from 10 to 90 bar absolute, more preferably, from 31 to 51 bar absolute.

6. A process according to claim 1, wherein the second ammonia stream and the first ammonia stream are the same, and the second ammonia stream and the first ammonia stream are heated together, wherein a heated first ammonia stream and a heated second ammonia stream are obtained from the same piece of process equipment.

7. A process according to claim 1, wherein the first hydrogen containing stream comprises from 60 mol % to 75 mol % H₂, from 70 mol % to 75 mol % H₂, or from 72 mol % to 75 mol %.

8. A process according to claim 1, wherein the second ammonia stream is heated to a temperature of from 700° C. to 1000° C., from 750° C. to 900° C., or from 800° C. to 850° C. before or after being fed to the parallel cracking pathway.

9. A process according to claim 1, wherein the second ammonia stream is heated to a temperature of from 450° C. to 650° C., from 500° C. to 600° C., or from 525° C. to 575° C. before or after being fed to the parallel cracking pathway.

10. A process according to claim 1, wherein the second hydrogen containing stream comprises from, from 50 mol % to 75 mol % H₂, or from 60 mol % to 75 mol % H₂.

11. A process according to claim 1, wherein the enriched hydrogen stream comprises from 70 mol % to 100 mol % H₂, from 75 mol % to 100 mol % H₂, from 80 mol % to 100 mol % H₂, from 85 mol % to 100 mol % H₂, or from 90 mol % to 100 mol % H₂.

12. A process according to claim 1, wherein the tail gas stream comprises from 3 mol % to 10 mol % ammonia, from 3.2 mol % to 7 mol % ammonia, or from 3.3 mol % to 5 mol % ammonia.

13. A process according to claim 1, wherein the tail gas stream comprises from 10 mol % to 70 mol % H₂, or from 20 mol % to 50 mol % H₂.

14. A process according to claim 1, wherein the first hydrogen containing stream comprises from 72 mol % to 75 mol % H₂, from 23 mol % to 25 mol % N₂, and less than 4 mol % NH₃.

15. A process according to claim 1, wherein the second hydrogen containing stream comprise from 72 mol % to 75 mol % H₂, from 23 mol % to 25 mol % N₂, and less than 4 mol % NH₃.

16. A process according to claim 1, wherein the parallel cracking pathway comprises two or more, three or more, four or more, or five or more secondary ammonia cracking reactors arranged sequentially and in fluid communication with one another.

17. A process according to claim 16, wherein the first of the two or more secondary ammonia cracking reactor comprises a nickel containing catalyst and the second of the secondary ammonia cracking reactors comprises a noble metal containing catalyst.

18. A process according to claim 17, wherein the cracked second ammonia stream is passed from the first of the two or more secondary ammonia cracking reactor to the second of the two or more secondary ammonia cracking reactors without an intermediate heating step.

19. A process according to claim 1, wherein the parallel cracking pathway comprises one or more heaters, preferably one or more electrical heaters.

20. A process according to claim 19, wherein the process comprises the step of re-heating the cracked second ammonia stream using a heater to produce a re-heated cracked second ammonia stream.

21. (canceled)

22. (canceled)

23. (canceled)

24. (canceled)
